(19) United States
(12) Patent Application Publication
(10) Pub. No.: US 2018/0150836 A1
(43) Pub. Date: May 31, 2018

(54) GENERATING TOKENS DYNAMICALLY USING PAYMENT KEYS

(71) Applicant: CA, Inc., New York, NY (US)

(72) Inventors: Sharath L. Kumar, Bangalore (IN); Sandeep Banisetti, Srikakulam (IN); Mohammed Mujeeb Kaladgi, Bangalore (IN); Yashwant Ramkishan Sawant, Parbhani (IN)

(21) Appl. No.: 15/363,772

(22) Filed: Nov. 29, 2016

(51) Int. Cl. G06Q 20/38; G06Q 20/40; G06Q 20/20

(52) U.S. Cl. CPC G06Q 20/3829; G06Q 2220/00; G06Q 20/206; G06Q 20/4014

(57) ABSTRACT

Techniques are disclosed relating to generating tokens dynamically using payment keys. In some embodiments, a computer system may receive a transaction authorization request including a transaction token. The computer system may, in some embodiments, identify a transaction account number and a plurality of payment keys that were sent to a user device. Further, in some embodiments, the computer system may generate an authentication token that is usable to validate the transaction token.

### BACKGROUND

### Technical Field

This disclosure relates generally to computer security and more particularly to generating tokens dynamically using payment keys.

### Description of the Related Art

Transactions using mobile devices such as mobile phones or smart cards are becoming more and more common. Many of these transactions are payment transactions that involve sensitive user information such as credit card data, passwords, user identification information, etc. Security of user transactions (e.g., payment transactions) is important to protect sensitive user information. In various situations, it may be desirable to encrypt or tokenize payment account information, for example, in order to prevent the account information from being intercepted. Further, authentication of a user and/or payment device (e.g., when a mobile device is used to perform payments) may be needed to verify that the user is an authorized user.

### SUMMARY

Techniques are disclosed relating to generating tokens dynamically using payment keys. In some embodiments, a computer system may receive a transaction authorization request for a transaction associated with a transaction account of a user. In some embodiments, the transaction authorization request may include an account identifier and a transaction token. In some embodiments, the computer system may identify, based on the account identifier, the transaction account number of the transaction account and a plurality of payment keys that were sent to a user device of a user. In some embodiments, the computer system may generate an authentication token by encrypting the transaction account number using format-preserving encryption based on a subset of the plurality of payment keys. In some embodiments, the authentication token may be usable to validate the transaction token.

### BRIEF DESCRIPTION OF THE DRAWINGS

FIG. 1 is a block diagram illustrating a system for conducting a transaction using a mobile device, according to some embodiments.

FIG. 2 is a block diagram illustrating an example transaction authentication system, according to some embodiments.

FIG. 3 is a block diagram illustrating an example transaction token generation system, according to some embodiments.

FIG. 4 is a block diagram illustrating an example transaction request authentication system, according to some embodiments.

FIG. 5 is a block diagram illustrating an example authentication token generation system, according to some embodiments.

FIG. 6 is a flow diagram illustrating an example method for validating a transaction authorization request, according to some embodiments.

FIG. 7 is a block diagram illustrating an example device, according to some embodiments.

### DETAILED DESCRIPTION

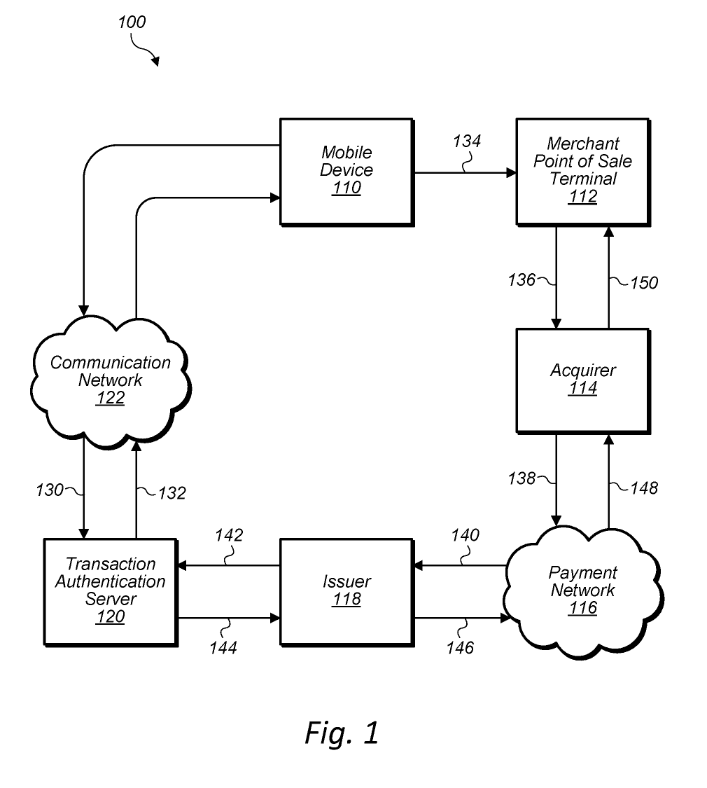

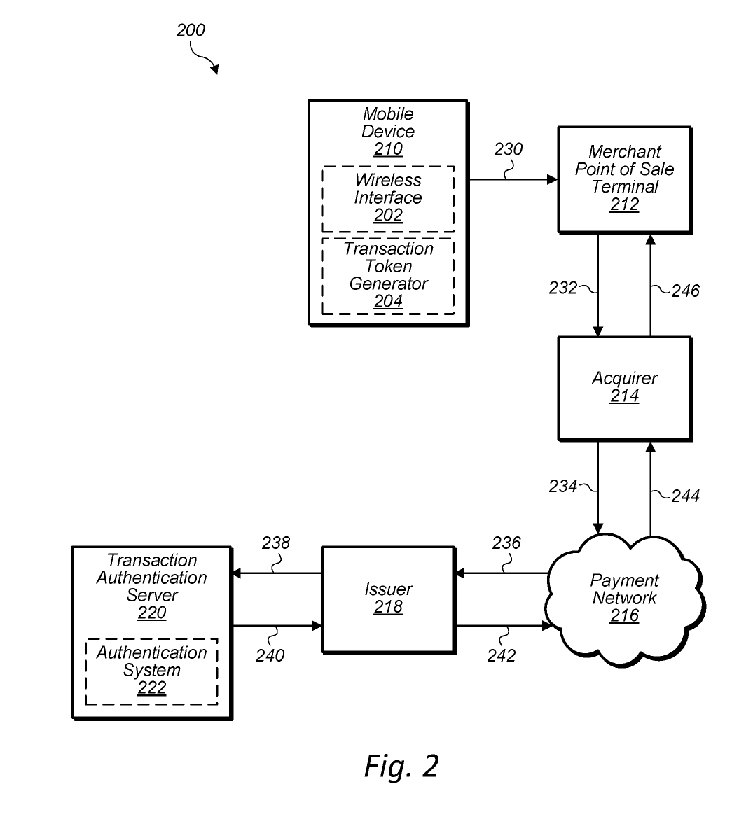

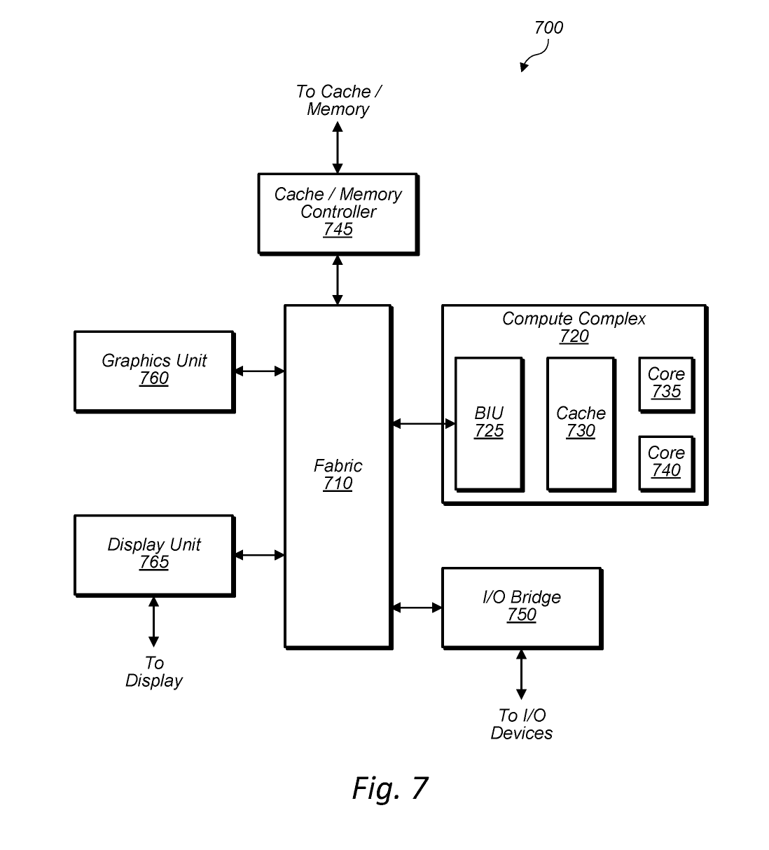

This disclosure initially describes, with reference to FIG. 1, an overview of a transaction authorization system. It then describes, with reference to FIGS. 2-6, example systems and methods for authorizing a transaction according to various embodiments. Finally, an example device is described with reference to FIG. 7.

FIG. 1 is a block diagram illustrating a system for conducting a transaction using a mobile device, according to an embodiment. In this embodiment, a user of a mobile device, such as mobile device 110, may use mobile device 110 to conduct financial transactions. Mobile device 110 may store various account information relating to one or more financial transaction instruments of the user, including a transaction account number (such as a primary account number (“PAN”)), card verification value (“CVV”), expiration date, etc. In conventional transaction systems, sensitive user information (e.g., transaction account number, CVV, expiration date, etc.) may be transmitted to various entities as part of the transaction authorization process. For example, in such systems, the user may transmit sensitive user information to a merchant point of sale terminal 112 using mobile device 110 as a financial transaction instrument. Merchant point of sale terminal 112 may include this sensitive user information in a transaction authorization request sent to an issuer 118 of the financial transaction instrument. However, such a system may allow for the interception of sensitive user information by unauthorized third-parties.

Various techniques have been developed to address this concern. One such technique is called “tokenization,” in which sensitive user information, such as a transaction account number, is substituted with a non-sensitive value, called a “token.” Tokenization may reduce the risk of harm posed by the interception of transaction information by unauthorized third-parties. In some embodiments, a token may be in the same format as the sensitive user information. For example, in some embodiments, a financial transaction instrument number may be formatted as a sixteen digit numerical value, such as “1111 2222 3333 4444.” In such embodiments, the first six digits, “1111 22” in the current example, may represent the financial transaction instrument issuer via a bank identification number (“BIN”). Further, in such embodiments, the last ten digits, “22 3333 4444” in the current example, may represent the PAN of the financial transaction account.

In various embodiments, a token may be generated in the same format as the financial transaction instrument number. In one embodiment, a token may be generated both for the BIN and the PAN. For example, in this embodiment, a token BIN value may be “8888 88” and a token PAN may be “55 6666 7777,” such that, when combined, the financial transaction instrument number token may be “8888 8855 6666 7777.” However, this described embodiment is provided merely as an example and is not intended to limit the scope of the present disclosure.

In some embodiments, a mobile device 110 may be configured for use as a financial transaction instrument. In such embodiments, mobile device 110 may request (130), via communication network 122, one or more tokens from transaction authentication server 120. In such embodiments, transaction authentication server 120 may securely store account information relating to one or more financial transaction accounts of the user. In response, transaction authentication server 120 may provision (132), via communication network 122, one or more tokens to mobile device 110 for use in conducting transactions.

In some embodiments, a user may enter into a transaction at merchant point of sale terminal 112 using mobile device 110. During the transaction, mobile device 110 may transmit (134) to merchant point of sale terminal 112 one or more tokens in place of one or more items of sensitive user information. For example, instead of transmitting a BIN and a PAN corresponding to a financial transaction instrument of the user, mobile device 110 may transmit a BIN token and a PAN token received from transaction authentication server 120 to merchant point of sale terminal 112. Merchant point of sale terminal 112 may include these tokens in the transaction authorization request sent to the issuer 118 to authorize the transaction. The transaction authorization request may be routed to acquirer 114, through payment network 116, to issuer 118.

After receiving the transaction authorization request (140), issuer 118 may analyze the request to process the transaction. Issuer 118 may recognize that the transaction authorization request includes one or more tokens in place of sensitive user information. For example, in one embodiment, issuer 118 may determine that the received BIN value corresponds to a tokenized BIN value and, therefore, that the received PAN value is a tokenized PAN value. Issuer 118 may then transmit (142) a request to transaction authentication server 120 to validate the PAN token.

In such embodiments, transaction authentication server 120 may compare the PAN token received from issuer 118 to the one or more PAN tokens previously provisioned to mobile device 110 in order to verify that the received token matches one of the provisioned tokens. Transaction authentication server 120 may then transmit (144) a result message to issuer 118. If transaction authentication server 120 is able to validate the PAN token, then the result message may include the sensitive user information of the user. For example, in response to a determination that the token received from issuer 118 matches a token previously provisioned to mobile device 110, transaction authentication server 120 may send a PAN of a financial transaction instrument of the user to issuer 118. In such an embodiment, issuer 118 may then process the transaction using the PAN received from transaction authentication server 120 and transmit a result of that processing to merchant point of sale terminal 112 (146-150).

In some embodiments, issuer 118 and transaction authentication server 120 are connected via a secure communication channel. Thus, in such an embodiment, the sensitive user information is not exposed to various entities (e.g., merchant point of sale terminal 112, acquirer 114, etc.) involved in processing the transaction. However, in such an embodiment, the one or more tokens provisioned by transaction authentication server 120 are potentially exposed to unauthorized third-parties both when they are provisioned (132) and during the transaction authorization process (136-140). Therefore, while the use of a token may protect sensitive user information from being intercepted by third-parties, an intercepted token may still be used to conduct fraudulent transactions.

Another technique to address the interception of sensitive user information by unauthorized third-parties involves transaction authentication server 120 distributing payment keys to mobile device 110 for use in generating a cryptogram to be included in a transaction authorization request. In some embodiments, mobile device 110 may request (130), via communication network 122, one or more payment keys from transaction authentication server 120. In such embodiments, transaction authentication server 120 may securely store account information relating to one or more financial transaction accounts of the user. In response, transaction authentication server 120 may provision (132), via communication network 122, one or more payment keys to mobile device 110 for use in generating a cryptogram. Further, in such an embodiment, transaction authentication server 120 may associate the one or more payment keys provisioned to mobile device 110 with the corresponding financial transaction account of the user.

In some embodiments, the payment keys may have one or more associated use restrictions. For example, in one embodiment, a given payment key may only be used to conduct a predetermined number of transactions (e.g., five transactions per payment key). In another embodiment, for example, a given payment key may have a cumulative transaction limit (e.g., $100 cumulative transaction limit per payment key). Thus, in various embodiments, the payment keys may need to be replenished as the associated use restrictions are exceeded.

In some embodiments, a user may enter into a transaction at merchant point of sale terminal 112 using mobile device 110. During the transaction, mobile device 110 may use a payment key to encrypt information to generate a cryptogram for the transaction. In one embodiment, the encrypted information may be specific to the transaction and may include, for example, a transaction amount, date, time, etc. In some embodiments, mobile device 110 may transmit the cryptogram, along with other identifying information, such as a PAN token, to merchant point of sale terminal 112. In such an embodiment, the cryptogram may be included, along with the token or other identifying information, in a transaction authorization request sent from merchant point of sale terminal 112 to issuer 118 to authorize the transaction. The transaction authorization request may be routed to acquirer 114, through payment network 116, to issuer 118.

After receiving the transaction authorization request (140), issuer 118 may analyze the request to process the transaction. Issuer 118 may recognize that the transaction authorization request includes the cryptogram and other identifying information, such as the PAN token. In such embodiments, issuer 118 may transmit (142) a request to transaction authentication server 120 to validate the cryptogram. Transaction authentication server 120 may use the PAN token or other identifying information to identify the corresponding user account. Upon identifying the user account, transaction authentication server 120 may identify the payment keys provisioned to mobile device 110. Transaction authentication server 120 may then generate a cryptogram in the same manner as mobile device 110 using the payment keys.

Transaction authentication server 120 may then compare the cryptogram received from issuer 118 to the cryptogram generated at the transaction authentication server 120 to verify that the two cryptograms match. Transaction authentication server 120 may then transmit (144) a result message to issuer 118. If transaction authentication server 120 is able to validate the cryptogram, then the result message may include the sensitive user information, such as the PAN, of the user. In such an embodiment, issuer 118 may then process the transaction using the PAN received from transaction authentication server 120 and transmit a result of that processing to merchant point of sale terminal 112.

In various embodiments, using a cryptogram may increase the security of performing a transaction using mobile device 110. However, in such embodiments, mobile device 110 may be required to frequently request additional payment keys from transaction authentication server 120. For example, mobile device 110 may be required to request additional payment keys each time the use restrictions for the previously-provisioned payment keys are exceeded. In various embodiments, such a request may coincide with the occurrence of a transaction. Thus, in such embodiments, mobile device 110 may be required to have connectivity to transaction authentication server 120 at the time of the transaction to be provisioned additional payment keys in order to complete the transaction. Further, such embodiments may still require the use of tokenization in order to prevent exposing sensitive user information to unauthorized third-parties.

### Example Systems

Turning now to FIG. 2, an embodiment of a transaction authentication system 200 is shown. In this embodiment, mobile device 210 may be configured for use as a financial transaction instrument. For example, in various embodiments, mobile device 210 may be configured for use as a financial transaction instrument via a mobile application installed thereon, via built-in software present on mobile device 210, via a website visited by mobile device 210, etc. As shown in FIG. 2, mobile device 210 may include wireless interface 202. In various embodiments, wireless interface 202 may be configured to use various communication protocols, such as near-field communications (NFC), WiFi Direct, Bluetooth, etc. Further, in some embodiments, wireless interface 202 may be operable to wirelessly communicate with merchant point of sale terminal 212.

Mobile device 210 may be configured to securely store various user information relating to one or more financial transaction instruments of the user, including a transaction account number (such as a PAN), CVV, expiration date, etc. Mobile device may also include transaction token generator 204. Transaction token generator 204 may be configured to generate transaction tokens dynamically using payment keys. In various embodiments, mobile device 210 may be configured to request a plurality of payment keys from transaction authentication server 220. In an embodiment, mobile device 210 may send the request for payment keys to transaction authentication server 220 prior to entering into a transaction with merchant point of sale terminal 212. In some embodiments, transaction authentication server 220 may securely store account information relating to one or more financial transaction accounts of the user. In response to the request, transaction authentication server 220 may transmit or provision a plurality of payment keys to mobile device 210 prior to the transaction. In some embodiments, for example, transaction authentication server 220 may provision 50 or more payment keys to mobile device 210 in response to the request. Mobile device 210 may be configured to securely store these payment keys for use in conducting transactions.

In some embodiments, a user of mobile device 210 may enter into a transaction with a merchant at merchant point of sale terminal 212. During the transaction, transaction token generator 204 may generate a transaction token for use in the transaction. Thus, in some embodiments, the transaction token may be generated dynamically by mobile device 210 at the time of the transaction. In such embodiments, transaction authentication server 220 may not be required to transmit the tokens to mobile device 210, thus reducing the risk that the tokens will be intercepted by an unauthorized third-party prior to the transaction.

In various embodiments, transaction token generator 204 may generate the transaction token using the payment keys provisioned to mobile device 210 by transaction authentication server 220. In some embodiments, transaction token generator 204 may generate the transaction token based on a subset of the plurality of payment keys. In one embodiment, for example, the transaction token may be generated based on seven payment keys. Further, in various embodiments, the transaction token may be generated based on a transaction account number relating to a financial transaction instrument of the user. In some embodiments, for example, the transaction account number may be the PAN of the financial transaction instrument. In other embodiments, however, the transaction account number may be the entire (i.e., BIN and PAN) financial transaction instrument number. In yet other embodiments, the transaction account number may be some other number that specifies the transaction account.

In various embodiments, transaction token generator 204 may generate the transaction token based on transaction data for the transaction. In some embodiments, transaction token generator 204 may generate the same transaction token multiple times using a given transaction account number and a given, ordered subset of payment keys. In various embodiments, therefore, transaction token generator 204 may generate the transaction token using an initialization vector to prevent unauthorized third-parties from inferring a relationship between the transaction token and the transaction account number. The initialization vector used by transaction token generator 204 may be based on various parameters. For example, in some embodiments, an initialization vector may be based on transaction data for the transaction, such as a transaction amount, transaction date, time of the transaction, expiration date of the financial transaction instrument, CVV, etc. In an embodiment, the transaction data may include data obtained from merchant point of sale terminal 212 during the transaction.

In various embodiments, transaction token generator 204 may generate the transaction token using format-preserving encryption (FPE). FPE, as used herein, refers to an encryption technique in which the input (or “plaintext”) and the output (or “ciphertext”) are in the same format. For example, in some embodiments, transaction token generator 204 may use the stored transaction account number as the input and generate the transaction token as an output in the same format. For example, in some embodiments, the transaction account number may be the PAN (e.g., “22 3333 4444”) of the financial transaction instrument number. In such embodiments, transaction token generator 204 may generate a transaction token that is in the same format (e.g., “99 8888 7777”).

At 230, mobile device 210 is shown in wireless communication with merchant point of sale terminal 212 via wireless interface 202. During the transaction, mobile device 210 may transmit the transaction token, along with other information, such as a BIN token, an account identifier, the transaction data used to generate the initialization vector, a key indicator for the subset of payment keys used to generate the transaction token, etc., to merchant point of sale terminal 212. In some embodiments, the transaction token may be substituted in place of sensitive user information. For example, instead of transmitting a transaction account number corresponding to the financial transaction instrument, mobile device 210 may transmit the transaction token in the same format as the transaction account number. In some embodiments, mobile device 210 may also transmit a BIN token and an account identifier to merchant point of sale terminal 212. In some embodiments, mobile device 210 may be configured to securely store a BIN token associated with issuer 218. In such embodiments, issuer 218 may determine that received sensitive user information, such as a PAN, is a tokenized version of the sensitive user information based on the received BIN value being in a range of token BIN values. In various embodiments, the account identifier may be an identifier assigned to the financial transaction account of the user by transaction authentication server 220. In such embodiments, transaction authentication server 220 may be configured to look up account information for the user based on the account identifier. Merchant point of sale terminal 212 may include this transaction token, along with other information such as the BIN token, the account identifier, the transaction data used to generate the initialization vector, the key indicator, etc., in the transaction authorization request sent to issuer 218 to authorize the transaction. The transaction authorization request may be routed to acquirer 214, through payment network 216, to issuer 218 (232-236).

After receiving the transaction authorization request (236), issuer 218 may analyze the request to process the transaction. Issuer 218 may recognize that the transaction authorization request includes a transaction token in place of sensitive user information. For example, in one embodiment, issuer 218 may determine that the received BIN value corresponds to a token BIN value and, therefore, that the received PAN value is a PAN token. In another embodiment, for example, issuer 218 may determine that the transaction authorization request includes a transaction token by comparing the transaction token against other account information accessible to issuer 218.

In some embodiments, issuer 218 may transmit (238) a transaction authentication request to transaction authentication server 220. In some embodiments, the request may include the account identifier of the transaction account and the transaction token. Further, in some embodiments, the transaction authentication request may include the transaction data used by mobile device 210 to generate the initialization vector. Further, in some embodiments, the transaction authentication request may also include a key indicator, which may be usable by transaction authentication server 220 to determine which subset of payment keys mobile device 210 used to generate the transaction token.

In various embodiments, transaction authentication server 220 may be configured to validate the transaction token by generating an authentication token and comparing the authentication token to the transaction token received from issuer 218. In various embodiments, transaction authentication server 220 may include authentication system 222. Authentication system 222 may be configured to generate an authentication token in a similar manner as used by mobile device 210 to generate the transaction token. In some embodiments, authentication system 222 may be configured to access account information of the user based on the received account identifier. For example, in such embodiments, authentication system 222 may be configured to determine the transaction account number of the financial transaction account of the user based on the received account identifier. Further, in such embodiments, authentication system 222 may be configured to determine the plurality of payment keys previously provisioned to mobile device 210 based on the account identifier. Further, in an embodiment, authentication system 222 may be configured to determine the subset of payment keys used by mobile device 210 to generate the transaction token based on the key indicator.

In various embodiments, authentication system 222 may generate the authentication token using FPE. For example, in some embodiments, authentication system 222 may use the determined transaction account number as the input and generate the authentication token as an output in the same format. For example, in some embodiments, the transaction account number may be the PAN (e.g., “22 3333 4444”) of the financial transaction instrument number. In such embodiments, authentication system 222 may generate an authentication token that is in the same format (e.g., “99 8888 7777”). In various embodiments, authentication system 222 may generate the authentication token based on a subset of the plurality of payment keys previously provisioned to mobile device 210. Further, in various embodiments, authentication system 222 may also generate the authentication token based on transaction data for the transaction. For example, in some embodiments, the transaction data may include a transaction amount, transaction date, time of the transaction, expiration date of the financial transaction instrument, CVV, etc. In an embodiment, the transaction data may include data obtained from merchant point of sale terminal 212 during the transaction. In an embodiment, the transaction data may include a time of the transaction. In such an embodiment, transaction authentication server 220 may independently determine at least part of the transaction data, for example based on the time of the transaction, and generate the initialization vector based on the determined transaction data.

In various embodiments, authentication system 222 may validate the received transaction token by comparing the transaction token with the authentication token to verify that the two tokens match. Transaction authentication server 220 may then transmit (240) a result message to issuer 218. If transaction authentication server 220 is able to validate the transaction token, the result message may include sensitive user information, such as the transaction account number of the user. In such an embodiment, issuer 218 may process the transaction using the transaction account number received from transaction authentication server 220 and transmit a result of that processing through payment network 216, to acquirer 214, to merchant point of sale terminal 212 (242-246).

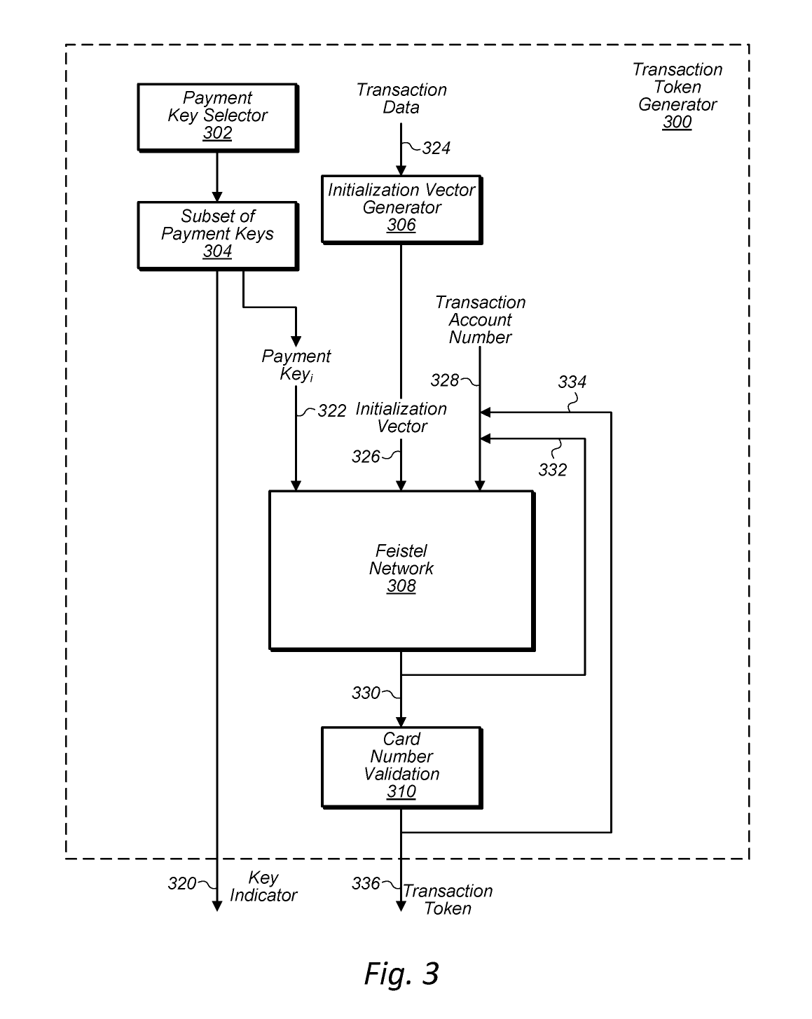

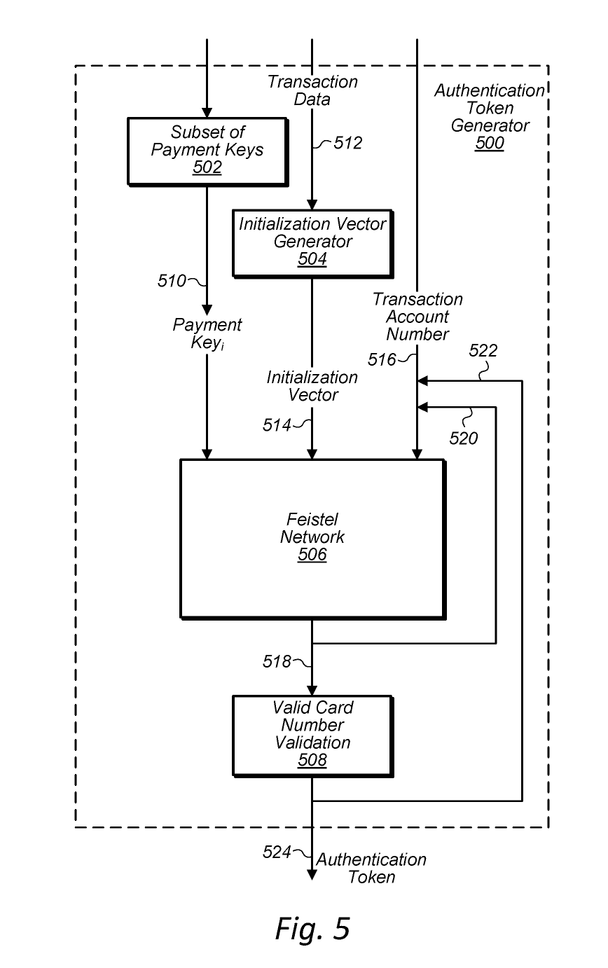

In various embodiments, the transaction authentication system of FIG. 2 may allow a user to perform a transaction using mobile device 210 as a financial transaction instrument while reducing the risk of interception of sensitive user information by unauthorized third-parties. In such embodiments, sensitive user information may not be exposed to the various entities (e.g., merchant point of sale terminal 212, acquirer 214, etc.) involved in processing the transaction. Additionally, in various disclosed embodiments, the tokens utilized to perform the transaction are generated dynamically using payment keys at the time of the transaction. Accordingly, in such embodiments, the tokens are not exposed to unauthorized third-parties prior to the transaction. Further, in various embodiments, the payment keys provisioned to mobile device 210 may be reused to dynamically generate transaction tokens. In systems in which only a single payment key is used to generate a cryptogram, for example, it may not be secure to reuse the same payment key in generating a cryptogram for a subsequent transaction. However, generating transaction tokens and authentication tokens by executing a plurality of rounds of a Feistel network using a subset of payment keys, such as in transaction token generator 300 of FIG. 3 and/or authentication token generator 500 of FIG. 5, may allow for payment keys to be securely reused to generate tokens in subsequent transactions. In various embodiments, the reused subset of payment keys may include either the same subset of payment keys or include some overlap with a previous subset of payment keys. In such embodiments, this may allow transaction token generator 204 to generate a transaction token for a transaction without being required to have connectivity to transaction authentication server 220 at the time of the transaction.

Turning now to FIG. 3, an embodiment of transaction token generator 300 is shown. Transaction token generator 300 may, for example, be transaction token generator 204 included on mobile device 210 and used to generate the transaction token transmitted from mobile device 210 to merchant point of sale terminal 212 in FIG. 2.

As shown in FIG. 3, transaction token generator 300 may include payment key selector 302. Payment key selector 302 may be configured to select a subset of payment keys 304 from the plurality of payment keys provisioned by transaction authentication server 220 in FIG. 2. In one embodiment, payment key selector 302 may select subset of payment keys 304 based on a number of transactions conducted using mobile device 210 since the payment keys were provisioned. For example, payment key selector 302 may select the first n payment keys as a first subset of payment keys 304 for generating a first transaction token since the payment keys were provisioned, where n is the number of payment keys in subset of payment keys 304. Further, payment key selector 302 may select the next n payment keys in the plurality (e.g., payment keys n+1 through 2n) as the second subset of payment keys 304. However, this described embodiment is provided merely as an example and is not intended to limit the scope of the present disclosure. In other embodiments, for example, subset of payment keys 304 selected by payment key selector 302 may not necessarily be sequential, and may be selected according to a predefined selection algorithm known at both mobile device 210 and transaction authentication server 220. In some embodiments, payment key selector 302 may also generate key indicator 320, which may be usable by authentication system 222 to determine which subset of payment keys transaction token generator 300 used to generate the transaction token. In various embodiments, for example, key indicator 320 may include a sequence counter. In some embodiments, the sequence counter may indirectly indicate the subset of payment keys 304, for example by indicating a number of transactions conducted since the payment keys were provisioned or input information for a selection algorithm used by payment key selector 302 to select subset of payment keys 304. In other embodiments, the sequence counter may directly indicate the subset of payment keys 304, for example by indicating a range of payment keys.

Transaction token generator 300 may also include initialization vector generator 306. In various embodiments, initialization vector generator 306 may be configured to generate an initialization vector for the transaction token based on various parameters. For example, in some embodiments, initialization vector generator 306 may generate the initialization vector based on transaction data 324 for the transaction, such as a transaction amount, transaction date, time of the transaction, expiration date of the financial transaction instrument, CVV, etc. In an embodiment, the initialization vector may be based on a current time of the transaction rounded off to a nearest interval (e.g., rounded off to the nearest 30 seconds). For example, in an embodiment, the initialization vector may be a transaction date and/or time (rounded off to a nearest interval). In one embodiment, the transaction data may include data obtained from merchant point of sale terminal 212 during the transaction. For example, in some embodiments, the transaction data may include a random and/or prime number received from merchant point of sale terminal 212 during the transaction, which may be used as an initialization vector. In some embodiments, initialization vector generator 306 may generate one or more initialization vectors for a given plurality of rounds of Feistel network 308. In other embodiments, however, initialization vector generator 306 may generate an initialization vector for each round of the plurality of rounds of Feistel network 308.

Transaction token generator 300 may also include Feistel network 308. In various embodiments, Feistel network 308 may be used to encrypt sensitive user information, such as a transaction account number, using FPE to generate a transaction token for a transaction. In some embodiments, transaction token generator 300 may execute a plurality of rounds of Feistel network 308 to generate the transaction token. For example, in one embodiment, at least seven rounds of Feistel network 308 are executed by transaction token generator 300.

Feistel network 308 may be configured to receive various inputs, such as payment keys 322 from subset of payment keys 304, initialization vector 326, and transaction account number 328. In various embodiments, a distinct payment key from subset of payment keys 304 is used for each round of Feistel network 308. For example, in each round of Feistel network 308, the distinct payment key for that round can be used with an encryption function executed during the round. In an embodiment, the round function may be a block cipher, such as the Advanced Encryption Standard (AES) cipher.

Feistel network 308 may be configured to operate in the following manner. In various embodiments, transaction account number 328 may be used as the plaintext input for Feistel network 308. The input (e.g., the transaction account number, according to an embodiment) may be split into a left portion and a right portion. In some embodiments, the left and right portions are of equal length. For each round i=0, 1, 2, . . . , n of Feistel network 308, the left portion and right portion may be computed as follows:

Lᵢ₊₁=Rᵢ

Rᵢ₊₁=Lᵢ⊕F(Rᵢ,kᵢ)

Where F is the round function, ⊕ is the XOR operation, Lᵢ is the left portion for a given round, Rᵢ is the right portion for a given round, and kᵢ is the payment key for a given round.

Thus, in various embodiments, the right portion may be encrypted using the round function and the distinct key for that round. The encrypted right portion may then be combined with the left portion, for example, using an XOR operation. The combination of the left portion and the encrypted right portion may equal the output of the right portion for that round. In various embodiments, the output of the left portion for a given round may be the output of the right portion in the previous round. In various embodiments, multiple rounds of Feistel network 308 may be executed in order to encrypt the transaction account number and generate the transaction token. For example, in one embodiment, at least seven rounds of Feistel network 308 are executed. In such embodiments, the output of each round of Feistel network 308 may be used as the input for the subsequent round (332). For example, in some embodiments, transaction account number 328 may be used as the initial plaintext input to Feistel network 308. After the executing the first round of Feistel network 308, the output from the first round may be used as the plaintext input for the second round. This process of using the output from one round as the plaintext input for a subsequent round may be repeated until transaction token generator 300 has executed the plurality of rounds of Feistel network 308.

Transaction token generator 300 may also include card number validation 310. In various embodiments, a credit card number may be required to satisfy a checksum formula in order to be considered a valid credit card number. For example, a checksum formula used to validate credit card numbers may be the Luhn formula. In various embodiments, the last digit of a credit card number may be a checksum value. In various embodiments, a Luhn check may be performed by applying the Luhn formula to the non-checksum values in the credit card number. If the result of the Luhn check and the checksum value match, then the credit card number may be deemed to be a valid credit card number. In some embodiments, card number validation 310 may be configured to verify that the output (330) of Feistel network 308, after executing the plurality of rounds, is a valid credit card number. In an embodiment, card number validation 310 may be configured to determine whether the encrypted transaction account number (330) is a valid card number by performing a Luhn check.

If card number validation 310 determines that the encrypted transaction account number 330 is a valid credit card number, then the encrypted transaction account number 330 may be output as transaction token 336. If, however, card number validation 310 determines that the encrypted transaction account number 330 in not a valid credit card number, then transaction token generator 300 may execute a second plurality of rounds of Feistel network 308. In some embodiments, the encrypted transaction account number 330 may be used as the initial plaintext input (334) for the second plurality of rounds of Feistel network 308. Further, in some embodiments, a distinct payment key from a second subset of payment keys 304 may be used for each round of the second plurality of rounds of Feistel network 308. After executing the second plurality of rounds of Feistel network 308, card number validation 310 may be configured to determine whether the newly encrypted transaction account number 330, after undergoing the first and second plurality of rounds of Feistel network 308, is a valid credit card number. This process of executing an additional plurality of rounds of Feistel network 308 in response to card number validation 310 determining that the encrypted transaction account number is not a valid credit card number may be repeated until a valid credit card number is obtained as transaction token 336.

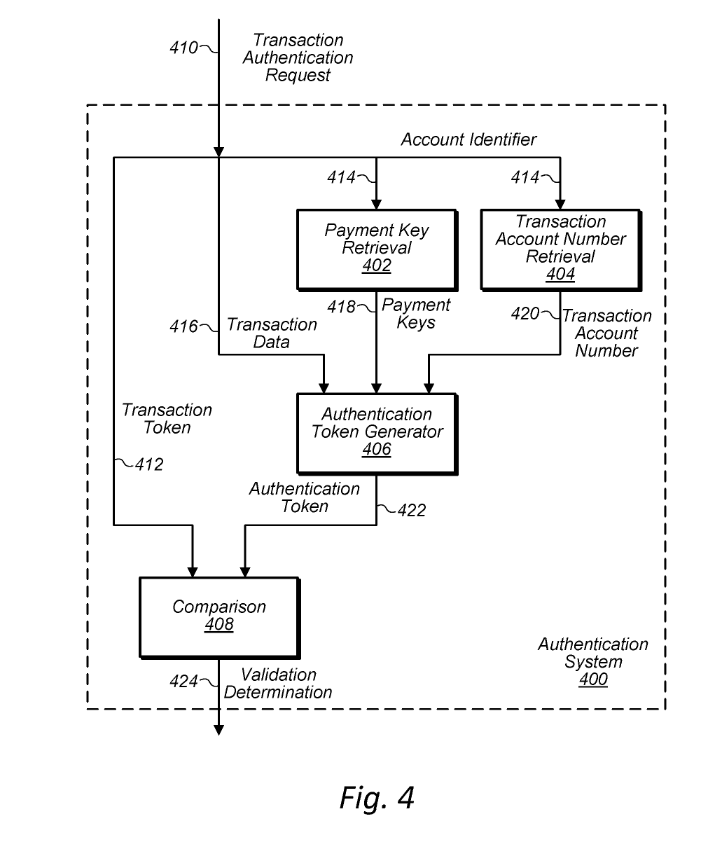

Referring now to FIG. 4, an embodiment of authentication system 400 is shown. Authentication system 400 may be included, for example, on transaction authentication server 220 in FIG. 2.

Authentication system 400 may be configured to receive transaction authentication request 410, for example from issuer 218. Transaction authentication request 410 may include various items of user and transaction information. For example, in some embodiments, transaction authentication request 410 may include transaction token 412, account identifier 414, transaction data 416, and/or a key indicator.

As shown in FIG. 4, authentication system 400 may include payment key retrieval 402. Payment key retrieval 402 may be configured to retrieve the payment keys 418 previously-provisioned to mobile device 210. In some embodiments, payment key retrieval 402 may identify payment keys 418 previously provisioned to mobile device 210 based on account identifier 414 received from issuer 218. Further, in various embodiments, payment key retrieval 402 may be configured to retrieve the subset of payment keys 304 used by transaction token generator 300 to generate transaction token 412. For example, payment key retrieval 402 may be configured to determine and retrieve the subset of payment keys from the plurality of payment keys provisioned to mobile device 210 based on the key indicator received in transaction authentication request 410. Thus, in some embodiments, payment keys 418 may be a subset of the plurality of payment keys. For example, payment keys 418 may, in some embodiments, include the same payment keys as subset of payment keys 304 of FIG. 3.

Authentication system 400 may be also include transaction account number retrieval 404. Transaction account number retrieval 404 may be configured to identify and retrieve transaction account number 420 corresponding to a financial transaction account of the user. In some embodiments, transaction account number retrieval 404 may identify the transaction account number based on the account identifier 414 received in transaction authentication request 410.

As shown in FIG. 4, authentication system 400 may use transaction data 416, payment keys 418, and transaction account number 420 as inputs to authentication token generator 406. Authentication token generator 406, as explained in more detail below with reference to FIG. 5, may be configured to generate authentication token 422 in the same manner that transaction token generator 300 used to generate transaction token 412. In an embodiment, transaction account number 420, authentication token 422, and transaction token 412 may all be in the same format, for example, a valid credit card number format.

Authentication system 400 also includes comparison 408. In various embodiments, comparison 408 may be configured to compare transaction token 412 received in transaction authentication request 410 with authentication token 422 generated by authentication token generator 406 to verify that the two tokens match. Comparison 408 may make authentication determination 424 based on the result of this comparison. Authentication system 400 may then transmit authentication determination 424 to issuer 218, for example in result message 240 of FIG. 2. If transaction token 412 and authentication token 422 match at comparison 408, authentication determination 424 may indicate that transaction token 412 is a valid token for the transaction account of the user. In the event that transaction token 412 is a valid token for the transaction account of the user, authentication system 400 may include transaction account number 420 in a result message sent to issuer 218. If, however, transaction token 412 and authentication token 422 do not match at comparison 408, authentication determination 424 may indicate that transaction token 412 is not a valid token for the transaction account of the user and transaction account number 420 may not be sent to issuer 218.

In FIG. 5, an embodiment of authentication token generator 500 is shown. Authentication token generator may be, for example, authentication token generator 406 of authentication system 400 in FIG. 4.

As shown in FIG. 5, authentication token generator 500 may be configured to receive as an input subset of payment keys 502. In various embodiments, subset of payment keys 502 may be the subset of payment keys retrieved by payment key retrieval 402 in FIG. 4 based on the account identifier and the key indicator. Authentication token generator 500, in various embodiments, may be configured to generate an authentication token by encrypting the transaction account number using FPE based on a subset of payment keys from the plurality of payment keys provisioned to mobile device 210.

Authentication token generator 500 may also include initialization vector generator 504. In various embodiments, initialization vector generator 504 may be configured to generate initialization vector 514 for the authorization token based on various parameters. For example, in some embodiments, initialization vector generator 504 may generate initialization vector 514 based on transaction data 512 for the transaction. In various embodiments, transaction data 512 may include a transaction amount, transaction date, time of the transaction, expiration date of the financial instrument, CVV, etc. or any combination thereof. For example, in an embodiment, initialization vector 514 may be based on a current time of the transaction rounded off to a nearest interval (e.g., rounded off to the nearest 30 seconds). In one embodiment, transaction data 512 may include data obtained from merchant point of sale terminal 212 during the transaction. In some embodiments, initialization vector generator 504 may generate one or more initialization vectors 514 for a given plurality of rounds of Feistel network 506. In other embodiments, however, initialization vector generator 504 may generate an initialization vector 514 for each round of the plurality of rounds of Feistel network 506.

Authentication token generator 500 may also include Feistel network 506. In various embodiments, Feistel network 506 may be used to encrypt sensitive user information, such as transaction account number 516, using FPE to generate an authentication token for a transaction. In some embodiments, authentication token generator 500 may execute a plurality of rounds of Feistel network 506 to generate the authentication token. For example, in one embodiment, at least seven rounds of Feistel network 506 are executed by authentication token generator 500.

Feistel network 506 may be configured to receive various inputs, such as payment keys 510 from subset of payment keys 502, initialization vector 514, and transaction account number 516. In various embodiments, a distinct payment key 510 from subset of payment keys 502 is used for each round of Feistel network 506. For example, in each round of Feistel network 506, the distinct payment key for that round can be used with an encryption function executed during the round. In an embodiment, the round function may be a block cipher, such as the AES cipher or any other suitable cipher.

Feistel network 506 may operate in the same manner as Feistel network 308 of transaction token generator 300 in FIG. 3. In various embodiments, transaction account number 516 may be used as the plaintext input for Feistel network 506.

In various embodiments, multiple rounds of Feistel network 506 may be executed in order to encrypt the transaction account number and generate the authentication token. For example, in one embodiment, at least seven rounds of Feistel network 506 are executed. In some embodiments, the number of rounds of Feistel network 506 implemented by authentication token generator 500 may correspond to a number of payment keys 510 included in subset of payment keys 502.

In various embodiments, the output of each round of Feistel network 506 may be used as the input for the subsequent round (520). For example, in some embodiments, transaction account number 516 may be used as the initial plaintext input to Feistel network 506. After the executing the first round of Feistel network 506, the output from the first round may be used as the plaintext input for the second round. This process of using the output from one round as the plaintext input for the subsequent round may be repeated until authentication token generator 500 has executed the plurality of rounds of Feistel network 506.

Authentication token generator 500 also includes card number validation 508. In some embodiments, card number validation 508 may be configured to verify that the output (518) of Feistel network 506 is a valid credit card number. In an embodiment, card number validation 508 may be configured to determine whether the encrypted transaction account number (518) is a valid card number by performing a Luhn check.

If card number validation 508 determines that the encrypted transaction account number 518 is a valid credit card number, then the encrypted transaction account number 518 may be output as authentication token 524. If, however, card number validation 508 determines that the encrypted transaction account number 518 in not a valid credit card number, then authentication token generator 500 may execute a second plurality of rounds of Feistel network 506. In some embodiments, the encrypted transaction account number 518 may be used as the initial plaintext input (522) for the second plurality of rounds of Feistel network 506. Further, in some embodiments, a distinct payment key from a second subset of payment keys 502 may be used for each round of the second plurality of rounds of Feistel network 506. After executing the second plurality of rounds of Feistel network 506, card number validation 508 may be configured to determine whether the newly encrypted transaction account number 518, after undergoing the first and second plurality of rounds of Feistel network 506, is a valid credit card number. This process of executing an additional plurality of rounds of Feistel network 506 in response to card number validation 508 determining that the encrypted transaction account number is not a valid credit card number may be repeated until a valid credit card number is obtained as authentication token 524.

### Example Methods

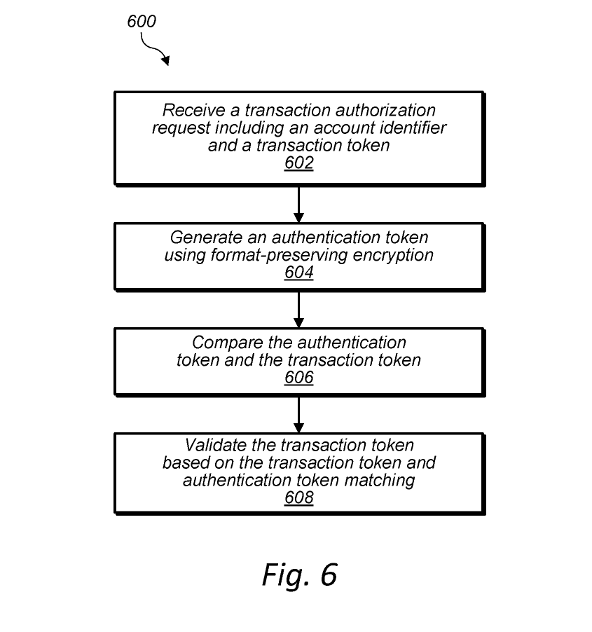

Turning now to FIG. 6, an example process flow 600 for an embodiment according to the present disclosure is shown. The process shown in FIG. 6 may be used in conjunction with any of the computer circuitry, systems, devices, elements, or other components disclosed herein, among other devices. In various embodiments, some of the process elements shown may be performed concurrently, in a different order than shown, or may be omitted. Additional method elements may also be performed as desired.

At 602, in the illustrated embodiment, a computer system receives a transaction authorization request for a transaction associated with a transaction account of a user. In some embodiments, the transaction authorization request may include, at least, an account identifier for the transaction account and a transaction token. Further, in some embodiments, the transaction token may be a token for a transaction account number and may be generated by a user device encrypting the transaction account number using FPE based on a subset of a plurality of the payment keys provisioned to the user device. In some embodiments, the transaction authorization request may also include a key indicator that indicates the subset of payment keys used by the user device to generate the transaction token. Further, in some embodiments, the transaction authentication request may include transaction data for the transaction.

At 604, in the illustrated embodiment, the computer system generates an authentication token using FPE. In some embodiments, the generating the authentication token may be based on the transaction account number, the subset of payment keys, and transaction data for the transaction. Further, in some embodiments, the computer system may generate the authentication token by executing a first plurality of rounds of a Feistel network to encrypt the transaction account number using a distinct payment key of the subset of payment keys for each round of the Feistel network. Further, in some embodiments, generating the authentication token may include using an initialization vector based on the transaction data. In various embodiments, the authentication token may be usable to validate the transaction token.

In some embodiments, generating the authentication token may include, after executing the first plurality of rounds of the Feistel network, determining whether the encrypted transaction account number is a valid card number. For example, in some embodiments, determining whether the encrypted transaction account number is a valid card number may include performing a Luhn check on the encrypted transaction account number. Further, in some embodiments, generating the authentication token may include executing a second plurality of rounds of the Feistel network to encrypt the transaction account number in response to a determination that the encrypted transaction account number is not a valid card number. In such embodiments, executing the second plurality of rounds may include using an output value of the first plurality of rounds as an input value to the second plurality of rounds of the Feistel network.

At 606, in the illustrated embodiment, the computer system compares the authentication token with the transaction token.

At 608, in the illustrated embodiment, the computer system validates the transaction token based on the transaction token and the authentication token matching. In some embodiments, in response to validating the transaction token, the computer system may send the transaction account number of the transaction account of the user to an issuer of the transaction account.

In some embodiments, the computer system may receive a second transaction authorization request for a second transaction. In such embodiments, the second transaction authorization request may include a second transaction token and the account identifier. Further, in such embodiments, the second transaction token may be generated at a time of the second transaction by the user device using FPE based on a second subset of the plurality of payment keys previously provisioned to mobile device 210 and second transaction data for the second transaction. In some embodiments, the second subset of payment keys may include one or more payment keys from the subset of payment keys used to generate the first authentication token.

Further, in such embodiments, the computer system may generate a second authentication token using FPE by executing a second plurality of rounds of the Feistel network to encrypt the transaction account number using a distinct payment key of the second subset of payment keys for each of the second plurality of rounds of the Feistel network. Additionally, in such embodiments, the computer system may validate the second transaction token based on the second transaction token and the second authentication token matching.

As one of ordinary skill in the art with the benefit of this disclosure will understand, in some cases the computer system may be made up of more than one individual computer device. For example, a server farm or a cloud-based server architecture may operate similarly to a single server, but it may actually include multiple computer devices.

### Example Device

Referring now to FIG. 7, a block diagram illustrating an example embodiment of a device 700 is shown. In some embodiments, elements of device 700 may be included within a system on a chip. In some embodiments, device 700 may be included in a mobile device, which may be battery-powered. In the illustrated embodiment, device 700 includes fabric 710, compute complex 720, input/output (I/O) bridge 750, cache/memory controller 745, graphics unit 760, and display unit 765.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and/or caches. For example, compute complex 720 may include 1, 2, or 4 processor cores, or any other suitable number. In one embodiment, cache 730 is a set associative L2 cache. In some embodiments, cores 735 and/or 740 may include internal instruction and/or data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions.

Cache/memory controller 745 may be configured to manage transfer of data between fabric 710 and one or more caches and/or memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches.

As used herein, the term “coupled to” may indicate one or more connections between elements, and a coupling may include intervening elements. For example, in FIG. 7, graphics unit 760 may be described as “coupled to” a memory through fabric 710 and cache/memory controller 745. In contrast, in the illustrated embodiment of FIG. 7, graphics unit 760 is “directly coupled” to fabric 710 because there are no intervening elements.

Graphics unit 760 may include one or more processors and/or one or more graphics processing units (GPU's). Graphics unit 760 may receive graphics-oriented instructions, such as OPENGL® or DIRECT3D® instructions, for example. Graphics unit 760 may execute specialized GPU instructions or perform other operations based on the received graphics-oriented instructions. Graphics unit 760 may generally be configured to process large blocks of data in parallel and may build images in a frame buffer for output to a display. Graphics unit 760 may include transform, lighting, triangle, and/or rendering engines in one or more graphics processing pipelines. Graphics unit 760 may output pixel information for display images.

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and/or low-power always-on functionality, for example. I/O bridge 750 may also include interfaces such as pulse-width modulation (PWM), general-purpose input/output (GPIO), serial peripheral interface (SPI), and/or inter-integrated circuit (I2C), for example. Various types of peripherals and devices may be coupled to device 700 via I/O bridge 750.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “mobile device configured to generate a transaction token” is intended to cover, for example, a device that performs this function during operation, even if the device in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile device, for example, would not be considered to be “configured to” perform some specific function, although it may be “configurable to” perform that function. After appropriate programming, the mobile device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by a computer system, a transaction authorization request for a transaction associated with a transaction account of a user, wherein the transaction authorization request includes an account identifier of the transaction account and a transaction token;
identifying, by the computer system based on the account identifier, a transaction account number of the transaction account and a plurality of payment keys that were sent to a user device of the user; and
generating, by the computer system, an authentication token by encrypting the transaction account number using format-preserving encryption (FPE) based on a subset of payment keys of the plurality of payment keys, wherein the authentication token is usable to validate the transaction token.

2. The method of claim 1, wherein generating the authentication token includes:
executing a first plurality of rounds of a Feistel network to encrypt the transaction account number using a distinct payment key of the subset of payment keys for each round of the Feistel network.

3. The method of claim 2, wherein generating the authentication token further includes:
after executing the first plurality of rounds of the Feistel network, determining whether the encrypted transaction account number is a valid card number.

4. The method of claim 3, wherein generating the authentication token further includes:
in response to a determination that the encrypted transaction account number is not a valid card number, executing a second plurality of rounds of the Feistel network to encrypt the transaction account number.

5. The method of claim 4, wherein executing the second plurality of rounds includes using an output value of the first plurality of rounds as an input value to the second plurality of rounds of the Feistel network.

6. The method of claim 3, wherein determining whether the encrypted transaction account number is a valid card number includes performing a Luhn check on the encrypted transaction account number.

7. The method of claim 1, wherein the transaction token is a token for the transaction account number and is generated by the user device encrypting the transaction account number using FPE based on the subset of payment keys.

8. The method of claim 1, wherein the transaction authorization request further includes a key indicator that indicates the subset of payment keys used by the user device to generate the transaction token.

9. The method of claim 8, further comprising:
determining, by the computer system, the subset of payment keys used by the user device to generate the transaction token based on the key indicator.

10. A non-transitory, computer-readable medium having instructions stored thereon that are executable by a computer system to perform operations comprising:
receiving a transaction authorization request for a transaction, wherein the transaction authorization request includes a transaction token, an account identifier of a transaction account of a user, and a key indicator, wherein the transaction token is a token for a transaction account number and was generated by a user device;
identifying, based on the account identifier, a plurality of payment keys provisioned to the user device;
determining, based on the key indicator, a subset of payment keys of the plurality of payment keys used by the user device to generate the transaction token;
generating an authentication token using format-preserving encryption (FPE) based on: the transaction account number, the subset of payment keys, and transaction data for the transaction;
comparing the transaction token and the authentication token; and
validating the transaction token in response to the transaction token and authentication token matching.

11. The non-transitory, computer-readable medium of claim 10, wherein the computer system includes a plurality of computer devices.

12. The non-transitory, computer-readable medium of claim 10, wherein the transaction data includes at least one of: a time of the transaction, a date of the transaction, or a value generated by a merchant device.

13. The non-transitory, computer-readable medium of claim 10, wherein the transaction account number, the transaction token, and the authentication token are in a valid credit card number format.

14. A method, comprising:
receiving, by a computer system, a transaction authorization request for a transaction associated with a transaction account of a user, wherein the transaction authorization request includes an account identifier for the transaction account and a transaction token, wherein the transaction token is generated by a user device encrypting a transaction account number using format preserving encryption (FPE) based on a subset of a plurality of payment keys provisioned to the user device;
generating, by the computer system, an authentication token using FPE by executing a plurality of rounds of a Feistel network to encrypt the transaction account number using a distinct payment key of the subset of payment keys for each round of the Feistel network;
comparing, by the computer system, the authentication token and the transaction token; and
validating the transaction token based on the transaction token and the authentication token matching.

15. The method of claim 14, further comprising:
in response to validating the transaction token, sending, by the computer system, the transaction account number of the transaction account of the user to an issuer of the transaction account.

16. The method of claim 14, wherein the transaction authorization request further includes transaction data for the transaction; and wherein the generating the authentication token includes using an initialization vector based on the transaction data.

17. The method of claim 14, wherein executing the plurality of rounds includes executing at least seven rounds of the Feistel network to encrypt the transaction account number.

18. The method of claim 14, wherein the plurality of payment keys are sent to the user device prior to the transaction; and wherein the transaction token is generated by the user device at a time of the transaction.

19. The method of claim 14, further comprising:
receiving a second transaction authorization request for a second transaction, wherein the second transaction authorization request includes a second transaction token and the account identifier, wherein the second transaction token is generated at a time of the second transaction by the user device using FPE based on a second subset of the plurality of payment keys and second transaction data for the second transaction;
generating, by the computer system, a second authentication token using FPE by executing a second plurality of rounds of the Feistel network to encrypt the transaction account number using a distinct payment key of the second subset of payment keys for each of the second plurality of rounds of the Feistel network; and
validating the second transaction token based on the second transaction token and the second authentication token matching.

20. The method of claim 19, wherein the second subset of payment keys includes one or more payment keys from the subset of payment keys.

21. The method of claim 14, wherein a number of the plurality of rounds of the Feistel network corresponds to a number of payment keys included in the subset of payment keys.
